(19) United States
(12) Patent Application Publication
(10) Pub. No.: US 2005/0270274 A1
(43) Pub. Date: Dec. 8, 2005

(54) Rapid input device

(76) Inventor: Raphael Bachmann, Zurich (CH)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/530,746

(22) PCT Filed: Oct. 8, 2003
(86) PCT No.: PCT/CH03/00659

§ 371 Date: Jul. 22, 2005

(30) Foreign Application Priority Data
Oct. 9, 2002 (CH) 1683/02

(51) Int. Cl. G09G 5/00

(52) U.S. Cl. 345/173

(57) ABSTRACT

The invention relates to a rapid input device comprising at least one input means, at least on input-capture unit and a computer. The input means defines at least one point by means of the spacial position thereof and the co-ordinates thereof are converted into electric signals in the at least one input capture unit and form at least one amount of data during a period of time from the points and the input thereof. The input capture unit is connected to the computer. Said computer is provided with means for processing the at least one amount of data. The input capture unit is connected to the computer in a wireless manner or by means of a cable. Said rapid input device is mobile and compact. The invention also relates to a method for operating said device and the uses thereof in pad devices, general computer work and rehabilitation.

This invention relates to a device for a rapid input of information to a computer according to claim 1 and a corresponding process according to Patent claim 50.

A text input system is known according to U.S. Pat. No. 6,008,799 that uses a touch screen. All letters and the most frequent words are displayed as keys and that requires 92 keys. The keys are arranged in alphabetical order, something that, on the basis of past experience, is subject to a frequency-based arrangement (M. Helander (ed.), Handbook of Human-Computer Interaction, Elsevier (1988), p. 479). In addition, a dictionary list is displayed. An area of about 12×20 cm is occupied on a monitor; this rather painfully restricts use on mobile units. In addition to the keys, the vowels can also be put in as so-called “flicks,” or stroke directions. There is one disadvantage here, however, and that has to do with the fact that only four flicks are provided (to the left, right, top and bottom), which is why the letter “U” cannot be put in with a flick. That makes any clean system setup impossible. The layout makes a rather confused and accordingly difficult-to-memorize impression because of the plurality of keys. The user must cover long distances with the crayon [stylus] to work the correct keys and that takes a lot of time. The dictionary window, where depending on the particular case one must also scroll, requires additional attentiveness and distracts from the actual writing process. No provision is made for connecting the flicks or lining them up next to each other.

U.S. Pat. No. 5,028,745 describes a device that detects or recognizes the position of a stylus on a tablet. Attuned oscillating circuits that are in the input surface of the tablet are triggered by means of a stylus guided on the tablet surface and that results in a change in the alternating current in the oscillating circuit. One can draw conclusions as to the position of the coil in the tablet from the change in the current.

U.S. Pat. No. 5,466,896 discloses an electromagnetic position detector that, with the help of a plurality of coils in a tablet surface, is capable of determining the position coordinates of an input stylus, where there is also a coil in the latter. Amplitude and phase position in the reception signal from digital data are used to determine the value of the coordinates.

EP0660218-A1 discloses a user interface device that employs a stylus for input purposes. Designated as “graphical keyboard,” it, among other things, has a key arrangement, such as it is known from the QWERTY keyboard. By putting on “strokes” (short strokes) starting from a key, the graphical keyboard is in a position with regard to the letters that have already been tapped in, for example, to perform the ALT function or the CONTROL function. It is also provided that two “strokes” can be combined in order, for example, using CONTROL-A, to put the letter “a” in as a capital letter. No provision is made for use by disabled persons, such as, for example, writing by the blind or in rehabilitation in general.

Some touch screen units offer handwriting recognition, but unfortunately, that does not work in the best possible fashion. There are those who try to decipher entire words and there are others where each letter is put in by handwriting. The letters must be put in with a special “graffiti” alphabet (U.S. Robotics, Palm Computing Division, Los Altos, Calif., U.S.A.). The handwriting is often misinterpreted by the unit and that means that the user is distracted from the actual writing process. Another problem inherent in these units is the rather expensive programming, which requires memory spaces and computer capacities with the consequence that the text that is put in is then displayed with a delay. No provision is made in the palm unit for separate use of the input device and the output device, something that makes many meaningful applications impossible.

U.S. Design Pat. No. D457,525 S describes a folding keyboard where no wireless connection is provided to the output device. Like a simple keyboard, the folding keyboard offers the disadvantage that the fingers and hands must perform relatively many and large movements to put in, for example, words or program commands. Many cases of RSI (Repetitive Strain Injury) can be traced back to the (intensive) use of computer keyboards.

Patent Document WO 02/08882 discloses a rapid writing system and unit that displays consonant keys and a vowel key. A pin can be guided in one of eight stroke directions, starting from each key. These stroke directions can be freely combined for purposes of text input. But no uses are provided where the text input can be accomplished separately from the display unit. This primarily involves a writing system; therefore, there are no such functions as, for example, CONTROL or ESCAPE, such as they are known for a computer keyboard. Besides, no provision is made for the employment of the writing system for units with physical keys.

Patent Document WO 00/17852 discloses an “Electronic Musical Instrument in Connection with Computer.” A computer is connected to a keyboard [key set] whose keys are arranged on the X/Y axes. Musical sounds can be produced and adjusted by means of input on the keys. It also has pedals by means of which one can influence loudness and echo effects. Combined on the keys and the pedals, it displays several input elements. But the latter are provided for working the keys and pedals in each case only on one axis. No provision is made for a combination of input elements - except for their simultaneous actuation. There is no cableless connection to the computer and no provision is made for a possibility to perform a force-feedback function. Input variants for electronic sound generation are described in detail (P. Gorges, L. Sasso, Nord Modular, Bremen, 2000).

The known documents make no provision for disabled or handicapped persons nor for those in rehabilitation.

Here is another disadvantage: Different input methods or even different input devices must be used. Besides, neither a model with wireless connection between the input and the computer nor a model for writing by the blind is provided here.

The object of this invention is to propose a device for the rapid input of information to a computer, which combines access to the complete functional capacity of a computer keyboard and a computer mouse or a similar interface and a music keyboard with function keys and different kinds of slide adjusters in a very small space and thus avoids the abovementioned disadvantages.

Another object is to provide a corresponding method.

This problem is solved according to the invention with a device according to the wording of Patent claim 1 and with a method according to the wording of Patent claim 50. The invention will be explained in greater detail below with reference to the drawings.

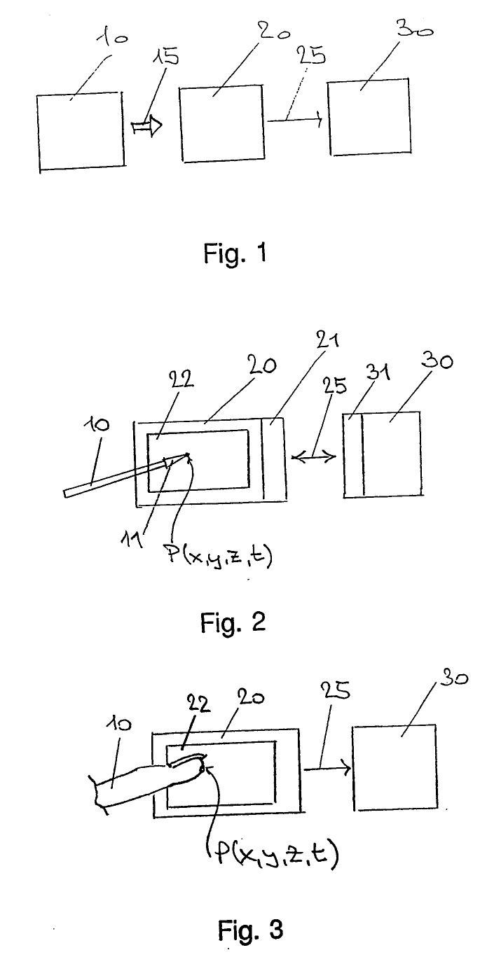

FIG. 1 shows a basic arrangement of a rapid input device.

FIG. 2 is a first exemplary embodiment with wireless connection between the input acquisition unit and the computer.

FIG. 3 is a second exemplary embodiment with a cable link between the input acquisition unit and the computer.

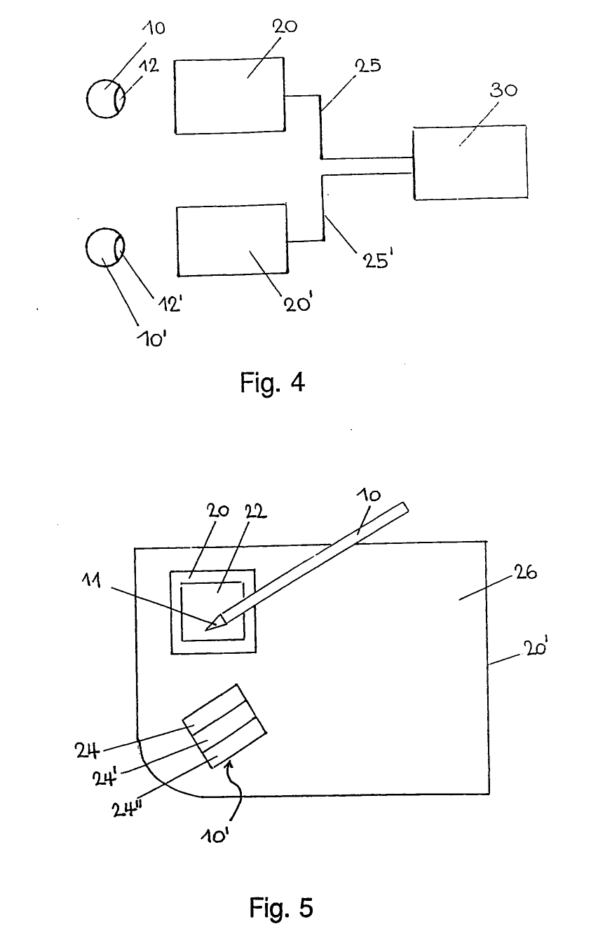

FIG. 4 is a third exemplary embodiment with two cameras as input acquisition units.

FIG. 5 is a fourth exemplary embodiment with two input means and two input acquisition units.

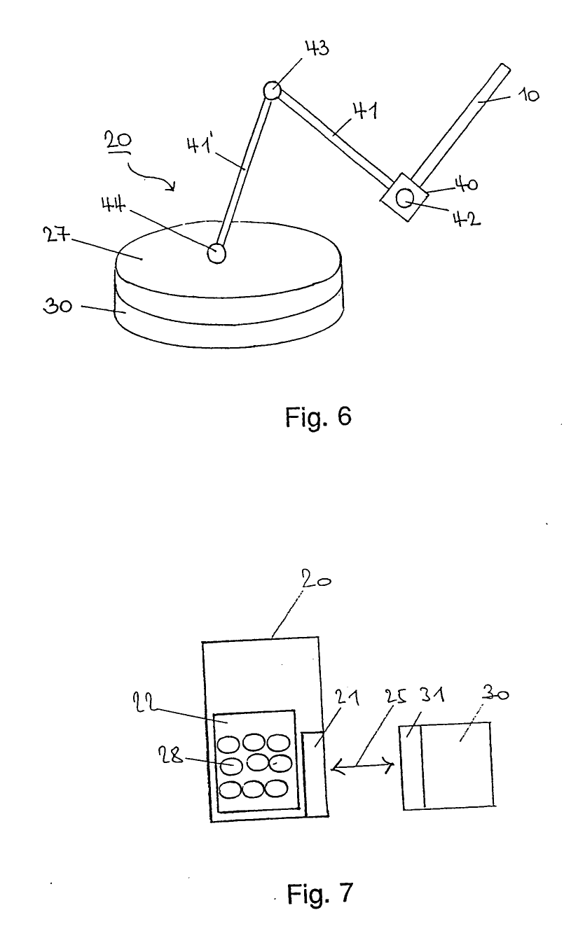

FIG. 6 is a fifth exemplary embodiment with an input mean that is firmly connected to the input acquisition unit.

FIG. 7 is a sixth exemplary embodiment with an input acquisition unit that has key elements.

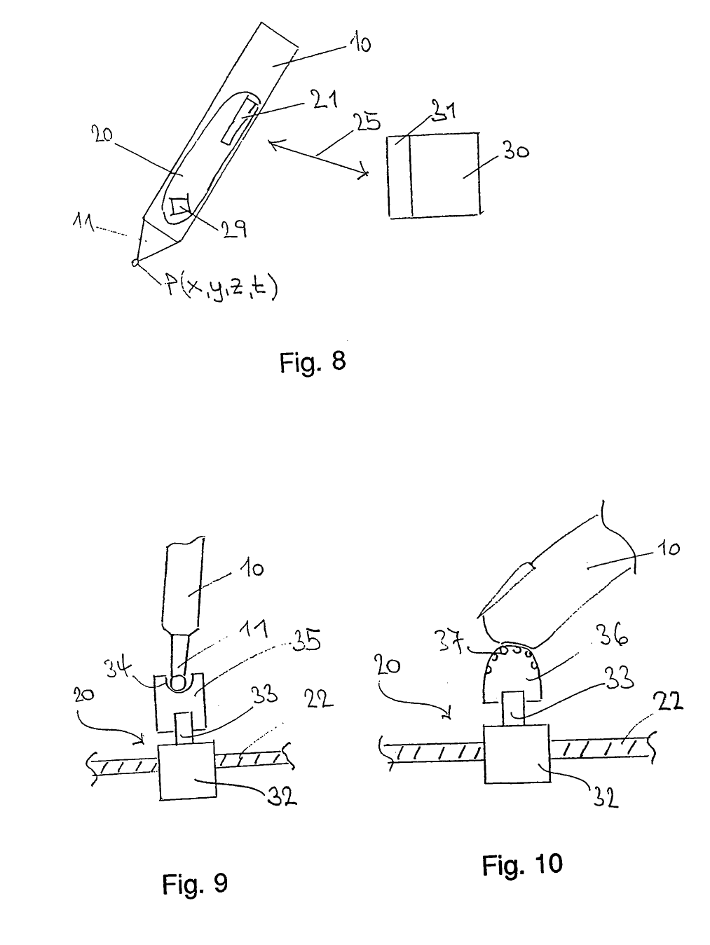

FIG. 8 is a seventh exemplary embodiment with input means and with an input acquisition unit integrated therein.

FIG. 9 is an eighth exemplary embodiment with a stylus as input means and a dynamometer in the input acquisition unit.

FIG. 10 is a ninth exemplary embodiment with a finger as the input means and a dynamometer in the input acquisition unit.

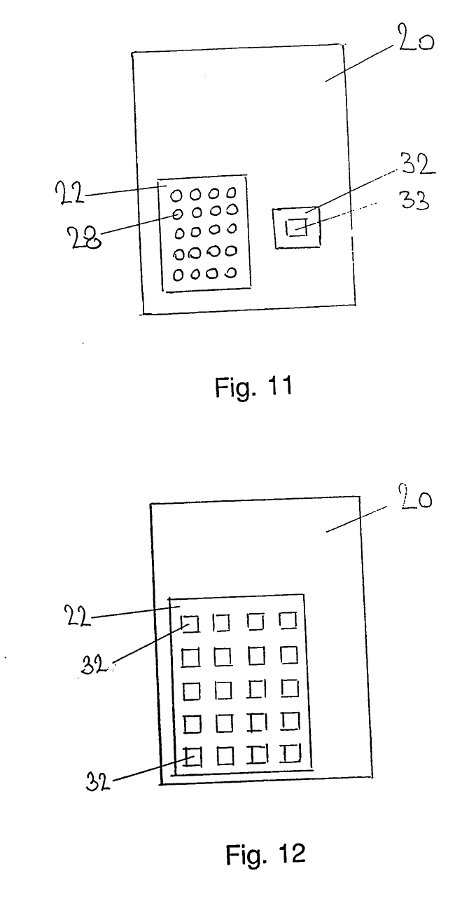

FIG. 11 is a tenth exemplary embodiment with a keyboard and a dynamometer in the input acquisition unit.

FIG. 12 is an eleventh exemplary embodiment with a field of dynamometers in the input acquisition unit.

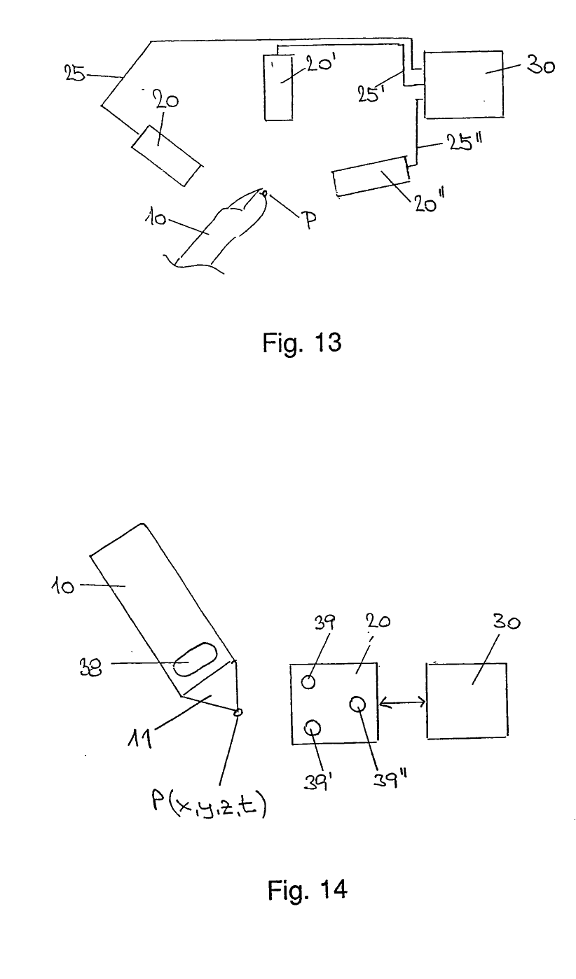

FIG. 13 is a twelfth exemplary embodiment with a finger as the input means and three infrared cameras as input acquisition units.

FIG. 14 is a thirteenth exemplary embodiment with a stylus as input means and ultrasound receiver modules in the input acquisition unit.

FIG. 1. shows the invention-based basic arrangement of a rapid input device. It comprises input means 10, an input acquisition unit 20 and a computer 30.

The term “input means” is taken here to signify objects or human body parts with which, at a certain spot, a point P is associated, which point is defined by its spatial and temporal position with coordinates (x, y, z, t) or which is thus described. At time t, in other words, the spatial position of point P is completely described with coordinates x, y, z in an initially as yet arbitrary coordinate system.

Point P represents a special case when its spatial and temporal position is defined only with coordinates (x, y, t), something that will be explained later on.

For example, a stylus represents an object with whose tip point P(x, y, z, t) is associated. The stylus represents a preferred object. But any kind of stylus-like object, such as pins, can be used.

One finger of one hand can also be used as input means and point (x, y, z, t), for example, is defined on the finger pad.

An input means is also a finger provided with a thimble, and here, the tip of the thimble defines point P(x, y, z, t).

Other body parts, such as a nose or a toe, can also be considered as input means and they would define point P(x, y, z, t). That, in particular, facilitates access for an input in case of physical disabilities of the most varied kind. An arm stump, with a stylus or stylus-like object that might possibly be attached to it, would also form an embodiment of input means.

A stylus or stylus-like objects are provided for guidance by hand, arm, mouth or foot.

Information is put in by input means 10 on the input acquisition unit 20, something that is indicated by the input arrow 15. Information is made up of a sequence of points P. The minimum information item forms an individual point [dot]. The information “stroke” is formed from two points. The distance between two points defines the stroke length, which, in turn, serves as the gradual input, such as, for example, for the loudness, the tone level, the color depth, etc. This is a graduated input that permits an essentially linear, logarithmic or similar association. Several or a plurality of points will form information items such as, for example, circles or pictorial structures of any kind.

Particularly distinguished are strokes and stroke combinations such as they are used, for example, in a rapid writing unit (WO 02/08882). Input elements are provided for input in eight directions—which lie in a stroke plane—where, on the one hand, associated with each individual vowel, there is one of the eight directions and, on the other hand, associated with one blank tap, there is one of the still-free eight directions. The combination of input elements in eight directions, that is to say, their direct, rapid lineup after each other, facilitates the rapid input for which the invention-based device is particularly suitable.

For special inputs, there are provided, perpendicularly to the stroke plane, additional, and in many cases, gradual input elements, which are very useful especially when employed as a music or drawing instrument, and they facilitate at least an intuitive input. This means that a total of at least nine directions are available as input elements.

Functions of a computer, such as the dimensioning and shifting of menu windows, can, however, also be associated with these input elements in at least nine directions. Or additional functions of a computer are available, such as, for example, zooming and scrolling in many windows, reversing and restoring inputs or functions such as COPY, PASTE, CUT, CLEAR, CURSOR UP, CURSOR DOWN, CURSOR LEFT, CURSOR RIGHT, CONTROL, ALT, ALT GR, FUNCTION, OPTION, ESCAPE, OPEN, CLOSE;

for screen adjustments: BRIGHTER, DARKER, REDDER, GREENER, BLUER;

for windows: MINIMIZING, MAXIMIZING, RESTORING, CLOSING;

for dialog windows: YES, NO, ABORT, CHANGE and

for the function keys: F1 to F12.

This would also include functions in a play and recording unit:

PLAY, PAUSE, STOP, RECORD, FORWARD, BACKWARD, NEXT TRACK, PREVIOUS TRACK, FIRST TRACK, LAST TRACK and VOLUME;

the functions in a text program or in a text input keyboard:

PAGE UP, PAGE DOWN, HOME, END, INSERT, DELETE, SHIFT, BACKSPACE, RETURN, DELETE; flush left, flush right, centered, grouped style, tabulator;

lines: type, thick, thin, normal, thicker, thinner;

the functions in a drawing program:

for objects: line, solidity, text; rotating around each axis, nearer, farther; for colors: black, white, transparent, red/magenta, blue/cyano, yellow/yellow parts; color parts can be put in gradually as a function of the stroke length.

This means that the invention-based input means can take care of all functions that usually define the input via mouse and keyboard.

Another possibility for rapid input, on the one hand, for input elements in at least nine directions and, on the other hand, via input elements defined by the embodiment position (the starting point of the eight input elements in the stroke level) in an X/Y field of the input surface—and its possible combinations—will result when these functions are attributes and processing steps in a sound data file. Such a sound data file consists of tone, sound, noise or any random combination of these three and thus every association of at least one Y with one X, whereby X corresponds to a point on a time axis. Y, for example, can correspond to a frequency or an amplitude of an attribute.

The following are provided as functions for random combination:
direct manipulation of the attributes, for example, amplitude and frequency of a sound data file,
complete or partial copying, insertion and erasure of a sound data file,
repeated playing of a sound data file (looping),
analysis (breakdown) of a sound data file according to various criteria (for example, Fourier analysis) and thus also the resultant generation of several new sound data files,
the synthesis of at least two sound data files,
the association of filters and effects with a sound data file,
the association of sound data files or the generating curves of an envelope for the control of loudness (amplitude), frequency of a filter (sound color), playing speed (tone level) over a certain lapse of time and over the course of another sound data file.

These, in other words, involve functions that are attributes of a sound data file or that are used for the processing of such attributes. These are also functions that facilitate the association of data files for the processing of attributes.

It has proven to be advantageous that functions for input that otherwise require different input methods and/or input devices can be handled with the combinations of the nine directions.

Accordingly, the rapid input device can also be referred to as a universal input device.

The input acquisition unit 20, as a rule, is a touch-sensitive surface, made as a tablet or a screen (U.S. Pat. No. 5,028,745: Position Detecting Apparatus; U.S. Pat. No. 5,466,896: Position Detector).

The coordinate system (x, y, z) is located on that surface, for example, with a coordinate origin in the upper left-hand corner. A positive z-coordinate or a z-component will be associated with all of the points that are above that surface.

The value ranges of the coordinates x, y, z, first of all, need not be restricted, that is to say, they move from +∞ to −∞. Depending on use, it is, however, practical to restrict these value ranges, in other words, to define the x values, for example, merely via the width of the screen used.

The z-component in a vertical direction to a tablet can, for example, be defined only in a narrow range of a few tenths to hundredths of a millimeter, where the value of z=0 is associated with the placement of a stylus without the exertion of force and where small negative z-values result as a function of the application pressure. But it is also conceivable to define z-values above a tablet in a range between 0 and 40 cm above the tablet level in order thus to facilitate contactless input.

Gradual values of an input element can be associated with the z-values. The range of the z-values can be present in a subdivided manner and an individual, nonidentical input element is associated with each of the subareas. One can thus see that the number of input elements need not be confined to nine.

Input acquisition unit 20 is capable of converting the coordinates of points P(x, y, z, t) or P(x, y, t) into electrical signals, something that can be done in a known way (U.S. Pat. No. 5,028,745: Position Detecting Apparatus; U.S. Pat. No. 5,466,896: Position Detector).

During the time spread, a sequence of points P are generated in the input acquisition unit and these points represent a data quantity M and thus the input as such. Data quantity M is provided for transmission to computer 30. This transmission takes place via a data cable, referred to in brief as cable, or in a wireless manner by means of a radio link (WO 01/18662-A1—Logitech, Inc.: Wireless Peripheral Interface with Universal Serial Bus Port), such as, for example, Bluetooth. This link between input acquisition 20 and computer 30 is indicated with an arrow 25. Computer 30 essentially comprises means for data processing of the data quantity M and output means, where the latter are not described here in any greater detail.

The basic arrangement described here is not restricted to a single input means and a single input acquisition unit. Arrangements with several input means and correspondingly associated input acquisition units will be described later.

FIG. 2 shows a first exemplary embodiment with wireless link between the input acquisition unit and the computer.

The input acquisition unit 20 has a transmitter/receiver module 21 by means of which a link is established with computer 30, where the computer likewise is equipped with a transmission/reception module 31. The transmission of data quantity M is indicated by arrow 25 and takes place, for example, according to the known Bluetooth standard. Input means 10 here are illustrated with a stylus upon whose tip 11 the point P(x, y, z, t) is defined. Point P lies on a touch-sensitive input surface 22, which, for example, is made as a touch screen.

FIG. 3 shows a second exemplary embodiment with a cable connection between the input acquisition unit and the computer.

Input acquisition unit 20 is connected via a cable connection with computer 30, something that is indicated by means of arrow 25. A finger is used here as input means and the point P(x, y, z, t) is defined here on the finger pad of said finger. Point P lies on a touch-sensitive input surface 22, which, for example, is made as a touch screen.

FIG. 4 shows a third exemplary embodiment with two cameras as input acquisition units.

Two eyes 10, 10′ are illustrated here as input means and the position of their pupils 12, 12′ is acquired by two cameras 20, 20′ as an image. Cameras 20, 20′, as a rule, are close to the eyes 10, 10′. For the location of the pupils, the cameras, per coordinates, generate the position points P1(x1, y1, t) and P2(x2, y2, t). Acquired over time, one gets from points P1 and P2 one data quantity M1 and M2 each, which in each case are fed to computer 30 via a cable connection 25, 25′. Data quantities M1 and M2 are so processed in computer 30 that a new data quantity M is formed from them and points P(x, y, z, t) now correspond to it.

Naturally, depending on the design of the cameras, a part of the signal and data processing can already be taken care of in the cameras. The essential thing is that the data quantity M is formed in computer 30 with points P(x, y, z, t).

Of course, signal-processing building blocks or computer building blocks are partly contained in the known manner in the cameras, and with these building blocks, one can already accomplish parts of the signal-processing procedure at the camera end.

The moment the pupils are covered by the eyelids, a sequence of points P(0, 0, 0, t) is generated, and it is referred to as “idle time,” and special functions can be associated with its length. For example, functions “pen down” and “pen up” can be associated with two different durations of that idle time. Or two short idle times that almost follow closely after each other are associated with a function, such as it is known as the double click of a mouse.

A special case is represented by the arrangement according to FIG. 4 with the presence of a single eye, whereby camera 20′ and connection 25′ are omitted.

For the position of pupil 12, the coordinates of the position points P1(x1, y1, t) are generated in camera 20. Acquired over time from points P1, one gets the data quantity M1, which is supplied to computer 30 via a cable connection 25. Data quantity M1 is so processed in computer 30 that a new data quantity M is formed from that and points P(x, y, t) now correspond to it. There is now no longer any z-coordinate.

The moment the pupil is covered by the eyelid, one gets a sequence of points P(0, 0, t), which can likewise be referred to as “idle time” and to whose length one can associate special functions as described earlier.

This kind of device can be used for text input and for computer work for people with tetraplegia or similar disabilities or for return to gainfully employed activity.

FIG. 5 shows a fourth exemplary embodiment with two input means and two input acquisition units for a right-handed person.

A stylus 10 is used as first input means and it is guided with the right hand and its tip 11 defines a point P1(x1, y1, z1, t), and on input surface 22, there is provided a first input acquisition unit 20 for input.

Three fingers of the left hand (not shown) are used as second input means 10′ and they form a set of fingers that consists of the index finger, the middle finger and the ring finger. The three fingertips are each located on a finger key 24, 24′, 24″, where each of them will define a point Pi(xi, yi, zi, t) with i=1, 2, 3, 4 and will represent a part of a second input acquisition unit 20′.

The latter furthermore includes a handrest 26 in which are inserted finger keys 24, 24′, 24″. Also inserted into the second input acquisition unit is, in the upper left-hand corner, the first input acquisition unit that is encompassed by the second one. Connection cable 25 and computer 30 are not illustrated in FIG. 5. It is advantageous here that both hands can be supported and can remain supported. With the three keys that are worked by the fingers of the left hand, access is facilitated to all functions of a computer with mouse and keyboard, for example, the widening or narrowing of menu windows, etc. The arms need not be moved or the hands need not be shifted around and that reduces the space required for the entire work environment. An embodiment for left-handed persons is designed accordingly.

As second input means, one can also use, for example, a second stylus guided by the left hand by means of which only a reduced number of inputs are performed on the input surface, such as, for example, access to a selection leading to all functions that a computer can perform.

This kind of device is used on a table that stands by itself or it is built into a mobile or stationary computer.

FIG. 6 shows a fifth exemplary embodiment with an input means that is firmly connected to the input acquisition unit.

Input means 10 is made as an object, preferably as a stylus, and at the lower end as a connecting part 40 via which input means 10 is mechanically firmly connected with the input acquisition 20, whereby connecting part 40 defines the point P(x, y, z, t).

Connecting part 40 is, on one side, connected with a lever arm 41 and has a joint 42 that permits movements along three axes. It is [connected] via a mobile system consisting of lever arms 41, 41′ and additional joints 43, 44 with the input acquisition unit 20, whereby lever arms and joints are components of the input acquisition unit. The mobile system consists of at least two lever arms and two joints; it can also have a more complicated structure and can consist of more than just two lever arms and joints.

A second joint 43 connects lever arms 41, 41′. It is made in the form of a hinge and thus permits movement around an axis. Lever arm 41′ ends in a third joint 44, which allows movements around two axes and which is housed in a platform 27. Angles are as a whole measured in three axes via protractors in joints 43, 44, whereby no angle measurement is required in joint 42 that belongs to connecting part 40. In that way, one can calculate the coordinates of point P. The sum of the length of lever arms 41, 41′ defines the value range of point P. The latter lies within a hemisphere with the radius of the two added lever arm lengths. The particular position of the connecting part 40 is acquired and transmitted to computer 30 that is integrated into platform 27. Computer 30 can also be located offside from the input acquisition unit 20 and can be connected to the latter either in a wireless manner or via a cable.

Electric motors are provided for joints 43, 44 via which motors the joints are driven. The electric motors are so controlled by means of software where a so-called “force feedback” function is facilitated. A force feedback is important as a possibility of checking on the actually performed input or on confirmation of said input. This feedback is important. It can also be handled optically or acoustically.

The protractors can be distributed in various ways in joints 43, 44: Either movements are performed accordingly in joint 43 around two axes and in joint 44 movements are performed around one axis or, in joint 44, movements are permitted around two axes and, in joint 43, movements are permitted around one axis. This means that, depending on the distribution of the protractors over the joints, 43, 44, it is possible to exchange the functions, although in each case one gets equivalent solutions.

FIG. 7 shows a sixth exemplary embodiment with an input acquisition unit, which displays key elements.

In the input surface 22, input acquisition unit 20 has a field with 3×3 keys 28. The finger of a hand, preferably a thumb, is used here as input means (not illustrated) and the point P(x, y, z, t) is defined at the tip of that finger. Point P lies on a touch-sensitive input surface 22 or on the key field with the 3×3 keys. The value range of point P(x, y, z, t) is very restricted here. It consists of precisely nine points with the t-dependence.

If a key is touched with the input means or with the thumb, then regardless of whether this is done in the center, on the left or the right edge of the key, one of the nine point values with the pertinent time will result. The existing key field will correspond to a touch-sensitive surface with a very gross resolution, that is to say, with a resolution of precisely 3×3 points. Nevertheless, this arrangement with its possible combinations in terms of the sequence of actuated keys over the passage of time facilitates a device for rapid input such as is required, for instance, for a rapid writing system (WO 02/08882).

The transmitter/receiver modules 21, 31, computer 30 and arrow 25 were described earlier in FIG. 2.

Naturally, the key field can also have more than 3×3 keys. The key field can also be worked by several fingers.

FIG. 8 shows a seventh exemplary embodiment with input means and an input acquisition unit integrated therein.

A stylus is provided as input means 10 on whose tip 11 point P(x, y, z, t) is defined. Point P lies at any random place in space, that is to say, wherever one can guide the tip of the stylus. This results in a natural restriction of the value range of point P.

Input acquisition unit 20 here is integrated in the stylus. Three accelerometers 29 that belong to the input acquisition unit 20 measure the accelerations in three directions. The coordinates of point P are determined from these data. The input acquisition unit 20 has a transmitter/receiver module 21 with whose help connection is established with computer 30, where the computer is likewise equipped with a transmission/reception module 31. Arrow 25 illustrates the transmission of data quantity M and this transmission takes place in a wireless manner. Naturally, the input acquisition unit 20 is also equipped with a power supply, for example, a storage battery.

Using the arrangement described, one can make three-dimensional movements accessible to input. In place of the wireless connection 25, the stylus can also be connected to the computer 30 via a connecting cable.

Advantageously, a larger number, or at least three accelerometers (29), are integrated into input means (10). This, on the one hand, makes for greater precision for the coordinates of point P and, on the other hand, a redundancy is created, which results in greater operational reliability.

FIG. 9 shows an eighth exemplary embodiment with a stylus as input means and a dynamometer in the input acquisition unit.

Input acquisition unit 20 with input surface 22 here comprises a dynamometer 32 that is attached in input surface 22 and whose shaft 33 protrudes out of the input surface 22 or out of the dynamometer 32. Located on shaft 33 is a guide part 35 that is firmly attached by its underside upon the shaft. On the top, guide part 35 has a well-like depression 34 in which the tip 11 of stylus 10 is inserted and moved. The deflections of tip 11 in depression 34 transmit the movements of the tip to the dynamometer and trigger force components in the dynamometer, which are converted into electrical signals. In that way, for example, the deflections of tip 11 are acquired in eight directions and thus form the input, especially the input for a known rapid writing system (WO 02/08882).

Dynamometer 32 permits not only movements in the x/y plane but also movements in the z-axis, which is positioned perpendicularly to the input acquisition unit 20.

FIG. 10 shows a ninth exemplary embodiment with a finger as input means and a dynamometer in the input acquisition unit.

Input acquisition unit 20 with input surface 22 here comprises a dynamometer 32 that is attached in input surface 22 and whose shaft protrudes out of the input surface 22 or out of the dynamometer 32. An additional guide part 36 is located on shaft 33 and this guide part is firmly attached by its underside upon the shaft. On the top, guide part 36 has a round, cupola-like and rough structure 37 on which rests the tip of finger 10. The deflections of the finger on structure 37 transmit the movements of the finger to the dynamometer and trigger force components in the dynamometer, where these force components are converted into electrical signals. In that way, for example, the deflections of the finger in eight directions form the input for a known rapid writing system (WO 02/08882). Typically, the deflections on the shaft caused by the finger amount to only about 0.1 to 0.2 mm. If one uses a mini-joystick in place of dynamometer 32, then the deflections on the shaft, caused by the finger, typically amount to up to about 3.0 mm.

FIG. 11 shows a tenth exemplary embodiment with a key field and a dynamometer in the input acquisition unit.

Input acquisition unit 20 has an input surface 22 that is equipped with a key field consisting of 4×5 keys 28. Next to it there is a dynamometer 32 that is firmly attached in input acquisition unit 20 and that protrudes out of it with the shaft 33. This arrangement is designed for two-handed input possibility and provides the following input means:
a stylus or a stylus-like object to work the dynamometer or for input via the dynamometer and a finger for the operation of the key field or for input via the key field; or
a finger for the operation of the dynamometer or for input via the dynamometer and a finger for operating the key field or for input via the key field.

Naturally, a right-handed person will operate the key field with the finger of the right hand and will guide the stylus with the left hand or will operate the dynamometer with a finger of the left hand. But this is not compulsory; other operating procedures are also conceivable.

FIG. 12 shows an eleventh exemplary embodiment with a field of dynamometers in the input acquisition unit.

Input acquisition unit 20 has an input surface 22 that is equipped with a field of 4×5 dynamometers 32. They are firmly attached in the input acquisition unit 20 so that the shaft of each dynamometer will protrude out of that unit. This arrangement is designed for two-handed or preferably single-handed input possibility and provides the following input means: preferably, at least one finger or an object, preferably a stylus or a stylus-like object to operate the dynamometers or for input via the dynamometers.

When an object is used, then the dynamometers preferably are made as illustrated in FIG. 9.

Dynamometer 32, used here, permits not only movements in the x/y plane but also movements in the z-axis, which is positioned perpendicularly to the input acquisition unit 20. In that way, the dynamometer is more universal because it simultaneously also facilitates the function of a key.

Naturally, one can also use any desired number of dynamometers.

FIG. 13 shows a twelfth exemplary embodiment with a finger as input means and three infrared cameras as input acquisition units.

A finger 10 is illustrated here as input means and the spatial position of the fingertip is acquired by three infrared cameras 20, 20′, 20″ as input acquisition units. The finger lies in the space that the three cameras form with their common acquisition field where the cameras must have a minimum mutual interval from each other and may not lie along one line.

For the position of the finger whose fingertip is associated with point P, the three cameras each generate coordinates P(x1, y1, t), P(x2, y2, t) and P(x3, y3, t) of point P, while index 1, 2, 3 is associated with the particular camera. Acquired over time, these coordinates in each case will yield a data quantity M1, M2 and M3, which are supplied to the computer 30 in each case via a cable connection 25, 25′ and 25″. The data quantities M1, M2 and M3 are so processed in computer 30 that a new data quantity M is formed from them and it now corresponds to the point P(x, y, z, t).

Naturally, depending on the design of the cameras, a part of the signal and data processing can already be performed by the cameras. The essential thing is that the data quantity M with the points P(x, y, z, t) is formed in computer 30.

Furthermore, partly signal-processing building blocks or computer building blocks are in the known manner contained in the cameras and these building blocks can be used to take care of parts of the signal-processing procedure already at the camera end. This arrangement, by the way, is not confined to three cameras. It was found that in the example described the problem can also be solved with two cameras. If, however, more than two cameras are used, then the precision of the determined position of point P will be greater and there will also be an additional redundancy. The choice of an infrared camera is by no means compulsory. Any desired camera can be used here.

FIG. 14 shows a thirteenth exemplary embodiment with a stylus as input means and ultrasound receiver modules in the input acquisition unit.

Stylus 10 is provided here as input means and point P(x, y, z, t) is defined at its tip. An ultrasound transmitter module 38 is integrated into the stylus. Input acquisition unit 20 has three ultrasound receiver modules 39, 39′ and 39″, where the intensity of the input signal is measured and, lastly, the data quantity M is again determined in each individual module.

This arrangement, by the way, is not confined to three ultrasound receiver modules. If, however, more than three ultrasound receiver modules are used, then the determined position of point P will be more precise and there will be an additional redundancy, something that is advantageous in terms of operational reliability.

The exemplary embodiments described permit the kind of input that is efficient, comfortable, practical and flexible, in particular, when it is done in a wireless manner.

When one uses eight stroke directions, then the number and the resultant possible combinations will result in an optimum input set. It facilitates access to the complete functional efficiency of a PC without additional input means and/or peripheral units but always with the same input method. The functions of writing, painting, music, Internet surfing, etc. [sic]. And the hands need not be shifted around, something that is advantageous when space is rather tight.

The invention-based solution is particularly indicated also for mobile units because many functions are housed in the very smallest space.

Rapid input devices can be used in rehabilitation and in the reintegration of disabled or handicapped persons, for example, people with tetraplegia or blind persons.

The process for the operation of a rapid input device will be described below.

In a first step using at least one input means, one generates coordinates of at least one point P in at least one input acquisition unit.

The generation of the coordinates of point P with an input means in an input acquisition unit was already described in FIG. 1.

In the third exemplary embodiment, one generates the coordinates of two points P1 and P2 with two input means in two input acquisition units (FIG. 4).

The most varied input means are used in the described exemplary embodiments: individual ones or several equal or different ones.

In a second step, the coordinates of at least one point Pare converted into electrical signals in at least one input acquisition unit 20 (U.S. Pat. No. 5,028,745 (Position Detecting Apparatus), U.S. Pat. No. 5,466,896 (Position Detector)).

In the third step, at least one data quantity M is formed from the electrical signals measured over time. In the third exemplary embodiment (FIG. 4), reference was made to the formation of two data quantities M1 and M2, each of which is supplied to computer 30 via a cable connection. The data quantities M1 and M2 are so processed in the computer that a new data quantity M is formed from them and points P(x, y, z, t) now correspond to it.

In a fourth step, data quantity M is transmitted in a wireless manner (WO 01/18662: Wireless Peripheral Interface with Universal Serial Bus Port) or via a cable connection to computer 30.

In a fifth step using the means of data processing, the data quantity M is processed in computer 30 and is made available for output means. The output means in their multiple versions will not be described in any greater detail here.

1. Rapid input device, comprising at least one input means at least one input acquisition unit and a computer wherein at least one input means by virtue of its position in terms of space defines at least one point whose coordinates are converted into electrical signals in at least one input acquisition unit and, over the passage of time, form at least one data quantity from the points and thus the input, and wherein at least one input acquisition unit is connected with the computer and means are provided in the computer for data processing of at least one data quantity.

2. Rapid input device according to claim 1, wherein the connection of the input acquisition unit to the computer is accomplished in a wireless manner or via a cable.

3. Rapid input device according to claim 1, wherein input elements are provided for input in eight directions, whereby the input elements are located in one stroke level.

4. Rapid input device according to claim 3, wherein gradual input elements are provided perpendicularly to the stroke level.

5. Rapid input device according to claim 1, wherein the input is provided in a gradual manner as a function of a stroke length.

6. Rapid input device according to claim 3, wherein input elements are provided in eight directions, whereby one of the eight directions is associated with each vowel.

7. Rapid input device according to claim 3, wherein input elements are provided in eight directions, whereby one of the eight directions is associated with up to eight selected consonants.

8. Rapid input device according to claim 3, wherein input elements are provided in eight directions, whereby one of the eight directions is associated with a blank tap.

9. Rapid input device according to claim 3, wherein an unlimited combination of input elements are provided in eight directions for rapid input.

10. Rapid input device according to claim 3, wherein input elements are provided in eight directions and their combinations, whereby functions of a computer are associated with each of these eight directions or their combinations.

11. Rapid input device according to claim 1, wherein input elements are provided in at least nine directions and their combinations, whereby functions of a computer are associated with each of these nine directions or their combinations.

12. Rapid input device according to claim 1, wherein input elements are provided in an X/Y field of the input surface of the input acquisition unit for execution, whereby X/Y coordinates—to each of which a function is associated—correspond to the execution position.

13. Rapid input device according to claim 10, wherein the functions are the dimensioning and shifting of menu windows and the zooming and scrolling in menu windows.

14. Rapid input device according to claim 10, wherein the functions involve the canceling and restoration of inputs.

15. Rapid input device according to claim 10, wherein the functions for screen adjustments are as follows: BRIGHTER, DARKER, REDDER, GREENER, BLUER.

16. Rapid input device according to claim 10, wherein the functions are: COPY, PASTE, CUT, CLEAR, CURSOR UP, CURSOR DOWN, CURSOR LEFT, CURSOR RIGHT, CONTROL, ALT, ALT GR, FUNCTION, OPTION, ESCAPE, OPEN, CLOSE, SHIFT, RETURN, DELETE, F1 to F12; for windows: MINIMIZING, MAXIMIZING, RESTORING, CLOSING and for dialog windows: YES, NO, ABORT, CHANGE.

17. Rapid input device according to claim 10 wherein the functions are first executed ready when they are closed with a blank tap.

18. Rapid input device according to claim 10, wherein the functions in a player and recorder unit involve: PLAY, PAUSE, STOP, RECORD, FORWARD, BACKWARD, NEXT TRACK, PREVIOUS TRACK, FIRST TRACK, LAST TRACK and VOLUME.

19. Rapid input device according to claim 10, wherein the functions involve PAGE UP, PAGE DOWN, HOME, END, INSERT, SHIFT, BACKSPACE, RETURN, DELETE; flush left, flush right, centered, grouped style, tabulator.

20. Rapid input device according to claim 10, wherein the functions for color parts are as follows: black, white, transparent, red/magenta, blue/cyano, yellow/yellow; for object: line, solidity, text; rotating around each axis, nearer, farther; and for lines: type, thick, thin, normal, thicker, thinner.

21. Rapid input device according to claim 10, wherein the functions are the attributes of a sound data file and that the functions are provided for their processing.

22. Rapid input device according to claim 10, wherein the functions are provided for the match-up of data files for the purpose of processing attributes.

23. Rapid input device according to claim 1, wherein the input can be influenced by muscular movements.

24. Rapid input device according to claim 1, wherein at least one point has coordinates.

25. Rapid input device according to claim 1, wherein the input means is at least an object, preferably at least a stylus whose tip defines at least one point.

26. Rapid input device according to claim 1, wherein the input means is at least a finger that defines at least one point.

27. Rapid input device according to claim 1, wherein the input means is at least a finger or a set of fingers and an object, preferably a stylus, whose tip defines the point.

28. Rapid input device according to claim 1, wherein the input means are the fingers of a hand, a nose or a toe, which define at least one point.

29. Rapid input device according to claim 1, wherein the input means is a finger provided with a thimble, whereby the tip of the thimble defines the point.

30. Rapid input device according to claim 1, wherein the input means is an object, preferably a stylus, and a connecting part whereby the latter is connected mechanically with the input acquisition unit and defines the point.

31. Rapid input device according to claim 30, wherein the input acquisition unit has at least two lever arms, which are movably connected with each other by at least two joints containing a total of at least three protractors, whereby one of them is housed in a platform in which the particular position of point of the connecting part is acquired.

32. Rapid input device according to claim 31, wherein of at least the two joints one of them permits movements around an axis, while the other one permits movements around two axes, as a result of which, point can assume every position within a hemisphere that is clamped on by the sum of the lengths of the lever arms.

33. Rapid input device according to claim 31, wherein electric motors are provided for the joints of the input acquisition unit via which the joints are driven, as a result of which, there is or there results a “force feedback” function.

34. Rapid input device according to claim 1, wherein the input acquisition unit is present in a manner integrated in the input means and is equipped with at least three accelerometers that are provided to determine the coordinates of point.

35. Rapid input device according to claim 1, wherein the input acquisition unit has a dynamometer that is mounted in a fixed manner in the input surface wherein the dynamometer has a shaft with guide part attached thereupon, and wherein a stylus is provided as input means whose tip is moved in the guide part as a result of which, these movements are provided to determine the coordinates of a point.

36. Rapid input device according to claim 1, wherein the input acquisition unit has at least one dynamometer that is mounted in a fixed manner on the input surface wherein at least one dynamometer has a shaft with additional guide part that is attached thereupon, and wherein at least one finger is provided as input means whose tip rests on the additional guide part as a result of which the movements of at least one finger are provided to determine the coordinates of point.

37. Rapid input device according to claim 1, wherein the input acquisition unit has a dynamometer and at least one key and wherein, as input means there are provided at least one finger or a finger and an object, preferably a stylus, whereby the movements of the input means are provided to determine the coordinates of at least one point.

38. Rapid input device according to claim 35, wherein the dynamometer is made in the form of a mini-joystick.

39. Rapid input device according to claim 1, wherein the input acquisition unit has at least two cameras preferably infrared cameras, and wherein a finger is provided as input means, whereby the movements of the finger are provided to determine the coordinates of point.

40. Rapid input device according to claim 1, wherein the input acquisition unit has at least three ultrasound receiver modules and wherein as input means there is provided an object, preferably a stylus with an integrated ultrasound transmitter module, whereby the movements of the input means are provided to determine the coordinates of point.

41. Rapid input device according to claim 25, wherein the object, preferably a stylus, is provided for the guidance of hand, arm, mouth or foot.

42. Rapid input device according to claim 1, wherein at least one point displays coordinates.

43. Rapid input device according to claim 1, wherein the input means is at least an eye, whereby the latter's pupil defines the point.

44. In combination the rapid input device according to claim 1 with a writing unit, in particular, a rapid writing unit.

45. In combination the rapid input device according to claim 1 in a rehabilitation system.

46. In combination the rapid input device according to claim 1 with a computer.

47. In combination the rapid input device according to claim 1 and an electronic musical instrument.

48. In combination the rapid input device according to claim 1 and an electronic drawing unit.

49. In combination the rapid input device according to claim 1 as a universal input device and a system.

50. Process for the operation of a rapid input device according to claim 1, wherein coordinates of at least one point are generated with at least one input means in at least one input acquisition unit wherein the coordinates are converted into electrical signals in the input acquisition unit wherein at least one data quantity is formed by the electrical signals over the passage of time, which is transmitted to the computer in a wireless manner or via a cable connection, and wherein the data quantity is processed in computer with the data processing means and is kept available for the output means.

51. Process according to claim 50, wherein with an object, preferably a stylus, or with at least one finger as input means, the input takes place via at least one key via at least one dynamometer via at least three protractors, via at least three accelerometers via a touch-sensitive input surface and/or via at least one ultrasound transmitter module, whereby coordinates of at least one point are generated in at least input acquisition unit.

52. Process according to claim 50, wherein the position of the pupils is acquired by one or two cameras as input acquisition unit in the form of an image using one eye or both eyes as input means, whereby coordinates of at least one point
